(19) United States
(12) Patent Application Publication
(10) Pub. No.: US 2005/0256948 A1
(43) Pub. Date: Nov. 17, 2005

(54) Methods and systems for testing a cluster management station

(76) Inventor: Shaotang Hu, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/846,468

(22) Filed: May 14, 2004

(51) Int. Cl. G06F 15/173

(52) U.S. Cl. 709/223

(57) ABSTRACT

Methods and systems for testing a cluster management station. A request for a trap to be generated is accessed at a trap generator. The trap generator can be software executing on a computer system. The trap is generated at the trap generator without requiring an actual failure associated with the trap.

### TECHNICAL FIELD

Embodiments of the present invention relate to methods and systems for testing a cluster management station.

### BACKGROUND ART

The term “cluster” is generally used to refer to or to describe a group of server computers, e.g., tens of server computer systems, that collectively handle user requests, for example, a transaction processing system. A cluster comprises a plurality of individual servers, or “nodes.” From the perspective of a user, a cluster appears to be a single system. For example, a user has no awareness of multiple computers and/or a division of effort among such multiple computers. Clusters are widely employed to handle heavy volumes of user transactions, e.g., across the internet, and/or to establish a level of fault or disaster tolerance.

The servers (nodes) of a cluster are generally loosely connected, each maintaining its own separate processor(s), memory, operating system and the like. Special communication protocols and system processors connect these nodes and allow them to cooperate, enabling enhanced levels of availability and providing support for mission-critical applications.

Simple Network Management Protocol (SNMP) is a portion of the internet protocol suite as defined by the Internet Engineering Task Force. SNMP can be used by any network attached devices to monitor and/or report any conditions that warrant such monitoring or reporting. Each Internet Protocol (IP) addressable system in a network, such as a node or a router, generally hosts a master agent for that system. A master agent typically limits its activity to parsing and formatting of the protocol. If a system has multiple manageable subsystems present, the master agent passes on the requests it receives to or from one or more subagents. These subagents model a variety of manageable subsystems while providing an interface to such subsystems for monitoring and management operations.

A node, e.g., a single server computer system, of a cluster typically comprises a master agent and a plurality of subagents. The subagents generally are associated with specific subsystems, e.g., a networking interface subsystem. For example, if a networking adapter card were to fail, the networking interface subagent would detect the failure and notify the master agent that the networking adapter card had failed. Such notifications are generally known as or referred to as “traps.” The master agent in turn then delivers or notifies a destination node, e.g., a management station, of the failure. Such destinations are typically listed in a configuration file.

Conventionally, testing of a management station and its software involved physically constructing a cluster of multiple nodes, installing appropriate software on all such nodes and communicatively coupling all nodes to the management station.

After the test cluster has been constructed, configured and is operational, under the conventional art, the management station and/or management station software is tested by creating actual faults on the servers comprising the cluster. For example, a test manager physically removes a networking adapter card from a server computer system. This process is typically repeated across different types of subsystems, e.g., memory subsystems, storage subsystems, processing subsystems and the like across most or all of the servers comprising the test cluster.

It is to be appreciated that such a test process presents myriad opportunities for electrical and/or physical damage to the hardware being utilized to support such tests. In addition, acknowledging such actual faults requires that a long and complex series of hardware and software interactions function. If any portion of such a chain of events fails, the original fault will likely not be detected. Hence, such conventional art techniques are generally unsuitable for use during intermediate stages of development and provide unsatisfactory isolation of faults within the problem-detecting mechanisms.

Further, such a manual process is not only labor intensive but also resource intensive. In order to construct a test cluster, a number of comparable test computer systems must be assembled and dedicated to the test process. If management station functions are to be tested for a variety of cluster operating systems, such testing is either performed sequentially in conjunction with large-scale system reconfiguration activities, or requires multiple clusters, each cluster requiring multiple server computers.

Thus a need exists for methods and systems for testing a cluster management station. A further need exists for utilizing a simple network management protocol trap generator in testing management station software. A still further need exists to meet the previously identified needs in a manner that is complimentary and compatible with conventional operations of clusters of server computer systems.

### SUMMARY OF THE INVENTION

Embodiments of the present invention provide for testing a cluster management station. Further embodiments of the present invention provide for utilizing a simple network management protocol trap generator in testing management station software. Still further embodiments of the present invention meet the previously identified need in a manner that is complementary and compatible with conventional operations of clusters of server computer systems.

Accordingly, methods and systems for testing a cluster management station are disclosed. A request for a trap to be generated is accessed at a trap generator. The trap generator can be software executing on a computer system. The trap is generated at the trap generator without requiring an actual failure associated with the trap.

### BRIEF DESCRIPTION OF THE DRAWINGS

FIG. 1A illustrates an exemplary cluster, in accordance with embodiments of the present invention.

FIG. 1B illustrates a trap generator, in accordance with embodiments of the present invention.

FIG. 2 illustrates a method of testing a cluster management station, in accordance with embodiments of the present invention.

FIG. 3 is a block diagram of a computer system, which may be used as a platform to implement embodiments in accordance with the present invention.

### BEST MODES FOR CARRYING OUT THE INVENTION

In the following detailed description of the present invention, simple network management protocol trap generator, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

### NOTATION AND NOMENCLATURE

Some portions of the detailed descriptions which follow (e.g., process 200) are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “executing” or “generating” or “computing” or “testing” or “reporting” or “determining” or “storing” or “displaying” or “recognizing” or “generating” or “performing” or “comparing” or “synchronizing” or “accessing” or “retrieving” or “transmitting” or “sending” or “selecting” or “determining” or “gathering” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### SIMPLE NETWORK MANAGEMENT PROTOCOL TRAP GENERATOR

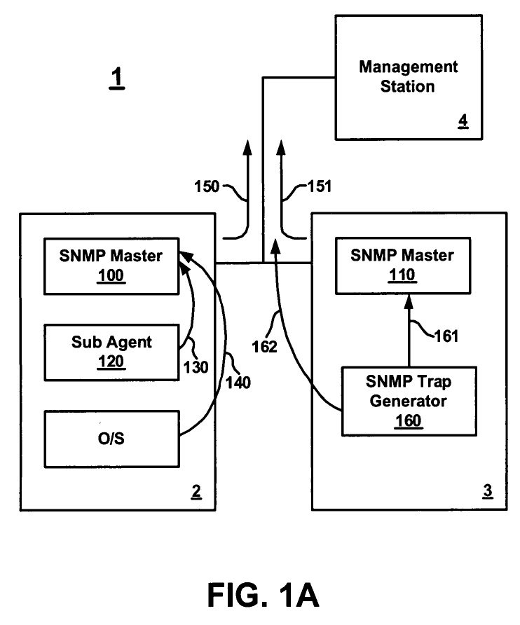

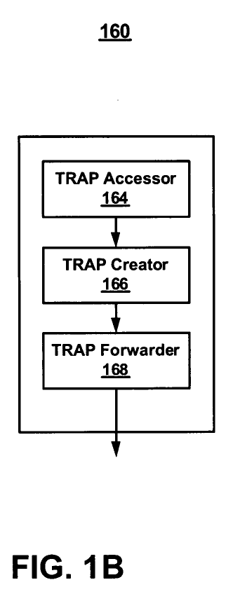

FIG. 1A illustrates an exemplary cluster 1, in accordance with embodiments of the present invention. Cluster 1 comprises a plurality of sever computer systems or nodes, for example nodes 2 and 3. Nodes 2 and 3 are well suited to a wide variety of types of computers, e.g., desktop computers, workstation computers, rack mounted servers, bladed servers and the like. Cluster 1 further comprises a network management node or management station 4. Nodes 2 and 3, as well as management station 4 are communicatively coupled, for example via a local area network, e.g., IEEE 802.11 or Ethernet.

Node 2 comprises simple network management protocol (SNMP) master agent 100, and a plurality of subagents, e.g., subagent 120. Typically, subagents interact and/or monitor a specific subsystem of node 2, and report status in the form of “traps,” e.g., trap 130, to SNMP master agent 100. The operating system may also send “traps,” e.g. trap 140, to SNMP master agent 100 for a variety of purposes, including reporting error conditions. SNMP master agent 100 in turn forwards such traps to management station 4 via communication 150.

In a manner similar to that of node 2, node 3 comprises an SNMP master agent 110. However, in accordance with embodiments of the present invention, node 3 comprises SNMP trap generator 160. SNMP trap generator 160 generates traps, e.g., trap 161, to SNMP master agent 110. SNMP master agent 110 of node 3 forwards such traps to management station 4 via communication 151. In contrast to the conventional art, SNMP trap generator 160 is not associated with any subsystem and need not monitor any aspect of node 3.

Simple network management protocol (SNMP) trap generator 160 generates trap messages, e.g., trap 161, to the SNMP master agent on the same node, e.g., SNMP master agent 110. In accordance with embodiments of the present invention, SNMP trap generator 160 is well suited to generating traps that simulate failures.

Alternatively, and in accordance with other embodiments of the present invention, SNMP trap generator can send traps directly to a management station, bypassing an SNMP master function. For example, SNMP trap generator 160 can generate trap 162 that goes directly to management station 4.

Such simulated failures generated by SNMP trap generator 160 are not limited to subsystems actually present on node 3, nor are they limited to subsystems actually present within cluster 1. Rather, SNMP trap generator 160 is well suited to generating traps simulating or representing a wide variety of types of system events.

FIG. 1B illustrates a trap generator 160, in accordance with embodiments of the present invention. Trap generator 160 comprises a trap accessor 164, trap creator 166 and trap forwarder 168.

Trap accessor 164 accesses requests to generate a trap. In a typical embodiment in accordance with embodiments of the present invention, such trap generation requests are specified, e.g., by a test manager, in a test description file. Such files can be described as a “script” for a test. Such a test description file can include a wide variety of instructions to trap generator 160, including, for example, a number of traps to be generated, type(s) of trap(s) to be generated and frequency of generating traps. It is to be appreciated that trap accessor 164 is not limited to accessing a test description file. In accordance with other embodiments of the present invention, trap generation requests can be made in a variety of ways, including in a user interaction.

Trap creator 166 is a software module that actually creates a trap, according to parameters of a trap generation request. The trap generation request is accessed by trap accessor 164 and guides trap creator 166.

Traps created by trap creator 166 are forwarded to a cluster management station by trap forwarder 168. Trap forwarder 168 can act as an SNMP subagent, forwarding traps to an SNMP master agent. Alternatively, trap forwarder 168 can forward traps directly to a cluster management station, without use of an SNMP master agent. For example, trap forwarder 168 can mimic some functions of an SNMP master agent, e.g., a communications interface, in order to send traps directly to a cluster management station.

In accordance with embodiments of the present invention, SNMP trap generator 160 is well suited to generating traps at a wide variety of rates. For example, SNMP trap generator 160 can generate traps at regular time intervals, e.g., one per minute. Alternatively, SNMP trap generator 160 can generate traps at random times. In another embodiment of the present invention, SNMP trap generator 160 can generate traps according to a statistical distribution, e.g., a Poisson distribution. Yet another rate for generating traps found to be useful is for SNMP trap generator 160 to generate traps as fast as possible.

Advantageously, a SNMP trap generator, such as SNMP trap generator 160, offers a number of advantages over the conventional art methods of testing management stations and management station software.

One such advantage over the convention art is a reduction in manpower required to perform a test. By utilizing an SNMP trap generator, actual faults do not need to be created. For example, a networking fault can be generated without removing a networking adapter card from a node. Another such advantage is that a test can be configured and conducted in much less time. For example, an SNMP trap generator can generate a number of traps in a time period that conventionally would be required to remove an exemplary networking adapter card.

Still another advantage over the convention art is a reduction in the number of computer systems, or nodes, required to conduct a test. For example, to achieve a desirable level of test coverage, a certain number of trap events should be generated. A given computer system is generally limited in the number of real faults that it can generate. For example, removal of a first networking adapter card may generate a fault and trap that is useful for testing. If a second and final networking adapter card is removed from the same system, the system is no longer communicatively coupled to the management station, and no trap can be communicated to the management station. A computer system, e.g., node 3, can generate a significantly greater number of traps per system utilizing embodiments in accordance with the present invention.

Yet another advantage of embodiments in accordance with the present invention over the conventional art is that not all systems comprising an SNMP trap generator need to be running the same operating system. This benefit derives from the simulated nature of the fault behaviors. Since a functioning cluster acting as a single system is not required, an SNMP trap generator can be operating on any system communicatively coupled to a management station under test. Acquiring and configuring a functional cluster of several machines utilizing the same operating system can be time consuming and expensive. In contrast, and in accordance with embodiments of the present invention, computer systems of a variety of configurations can be utilized for testing, at much less cost in terms of time, manpower and monetary outlays.

Under the conventional art, it is highly beneficial to have all systems in a common location, e.g., in a test room. Such commonality of location aided the manual nature of physically interacting with nodes of the test cluster. However, in accordance with embodiments of the present invention, a system operating a SNMP trap generator needs little or no physical intervention, and can be located essentially anywhere within communication connectivity of the management station.

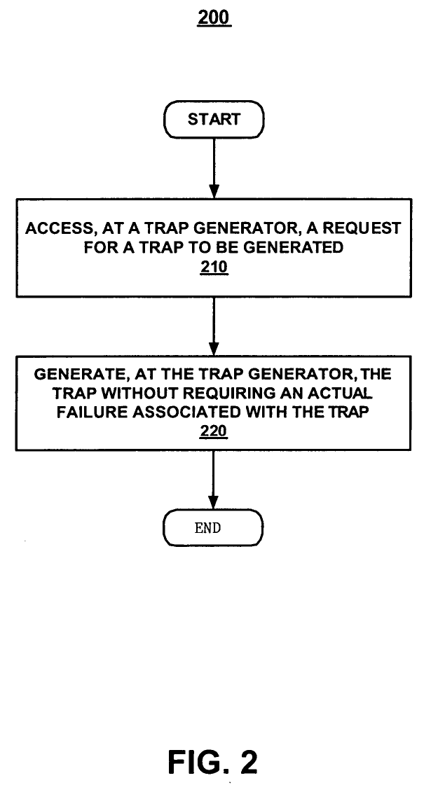

FIG. 2 illustrates a method 200 of testing a cluster management station, in accordance with embodiments of the present invention. In block 210, a request for a trap is generated at a trap generator. The trap generator can be software executing on a computer system. The computer system is communicatively coupled to the management station.

In block 220, the trap is generated at the trap generator without requiring an actual failure associated with the trap.

As discussed previously, embodiments in accordance with the present invention are well suited to generating traps at a wide variety of rates. For example, a trap generator can generate traps at regular time intervals, e.g., one per minute. Alternatively, a trap generator can generate traps at random times. In another embodiment of the present invention, an SNMP trap generator can generate traps according to a statistical distribution, e.g., a Poisson distribution. Yet another rate for generating traps found to be useful is for an SNMP trap generator to generate traps as fast as possible.

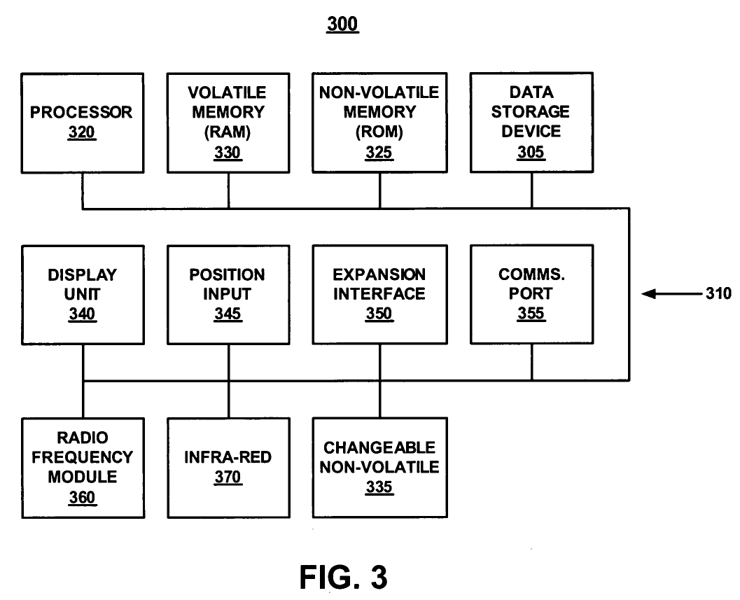

With reference now to FIG. 3, some embodiments in accordance with the present invention comprise computer-readable and computer-executable instructions that reside, for example, in computer system 300. It is appreciated that computer system 300 of FIG. 3 is exemplary only, and that embodiments in accordance with the present invention can operate within a number of different computer systems, including general-purpose computer systems, embedded computer systems, laptop computer systems, hand-held computer systems, networked computer systems, server computer systems and the like.

FIG. 3 is a block diagram of a computer system 300, which may be used as a platform to implement embodiments in accordance with the present invention. Computer system 300 includes an address/data bus 310 for communicating information, a central processor 320 functionally coupled with the bus 310 for processing information and instructions, a volatile memory 330 (e.g., random access memory RAM) coupled with the bus 310 for storing information and instructions for the central processor 320 and a non-volatile memory 325 (e.g., read only memory ROM) coupled with the bus 310 for storing static information and instructions for the processor 320. Computer system 300 also optionally includes a changeable, non-volatile memory 335 (e.g., flash) for storing information and instructions for the central processor 320 that can be updated after the manufacture of system 300.

Computer system 300 may also include optional data storage device 305, for example, a magnetic and/or optical rotating disk, CD/DVD drive, floppy disk and/or tape drive and the like for storing vast amounts of data.

Also included in computer system 300 of FIG. 3 is an optional positional input device 345. Device 345 can communicate position information and/or command selections to the central processor 320. Device 345 may take the form of a touch sensitive digitizer panel, mouse, trackball and/or a keyboard device.

The optional display unit 340 utilized with the computer system 300 may be a liquid crystal display (LCD) device, cathode ray tube (CRT), field emission device (FED, also called flat panel CRT), light emitting diode (LED), plasma display device, electro-luminescent display, electronic paper or other display device suitable for creating graphic images and alphanumeric characters recognizable to a user of computer system 300.

Computer system 300 also optionally includes an expansion interface 350 coupled with the bus 310. Expansion interface 350 can implement many well known standard expansion interfaces, including without limitation the Secure Digital card interface, universal serial bus (USB) interface, Compact Flash, Personal Computer (PC) Card interface, CardBus interface, Peripheral Component Interconnect (PCI) interface, mini-PCI interface, IEEE 1394, Small Computer System Interface (SCSI), Personal Computer Memory Card International Association (PCMCIA) interface, Industry Standard Architecture (ISA) interface, or RS-232 interface. It is appreciated that external interface 350 may also implement other well known or proprietary interfaces. In one embodiment in accordance with the present invention, expansion interface 350 may consist of signals substantially compliant with the signals of bus 310.

A wide variety of well known expansion devices may be attached to computer system 300 via expansion interface 350. Examples of such devices include without limitation rotating magnetic memory devices, flash memory devices, digital cameras, wireless communication modules, digital audio players and Global Positioning System (GPS) devices.

System 300 also optionally includes a communication port 355. Communication port 355 may be implemented as part of expansion interface 50. When implemented as a separate interface, communication port 355 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 300 optionally includes a radio frequency module 360, which may implement a mobile telephone, a pager, or a digital data link. Radio frequency module 360 may be interfaced directly to bus 310, via communication port 355 or via expansion interface 350.

System 300 optionally includes an infrared (IR) light signaling transceiver 370. IR transceiver 370 may typically be coupled to a communication port, for example communication port 355. It is appreciated that there are other well known arrangements of IR port 370, including connection directly to bus 310. Infrared port 370 may serve to communicate with other computer systems over short range, line of sight paths. Infrared transceiver 370 may be compliant with Infrared Data Association (IrDA) standards.

Embodiments of the present invention provide for testing a cluster management station. Further embodiments of the present invention provide for utilizing a simple network management protocol trap generator in testing management station software. Still further embodiments of the present invention meet the previously identified need in a manner that is complementary and compatible with conventional operations of clusters of server computer systems.

Embodiments in accordance with the present invention, methods and systems for testing a cluster management station, are thus described. While the present invention has been described in particular embodiments, it should be appreciated that the present invention should not be construed as limited by such embodiments, but rather construed according to the below claims.

1. A method of generating traps for testing a cluster management station comprising:
accessing, at a trap generator, a request for a trap to be generated;
generating, at said trap generator, said trap; and
wherein said trap is generated without requiring an actual failure associated with said trap.

2. The method according to claim 1 wherein said generating comprises generating a plurality of traps at a regular interval.

3. The method according to claim 1 wherein said generating comprises generating a plurality of traps at random intervals.

4. The method according to claim 1 wherein said generating comprises generating a plurality of traps according to a statistical distribution.

5. The method according to claim 4 wherein said statistical distribution is a Poisson distribution.

6. The method according to claim 1 wherein said generating comprises generating a plurality of traps as fast as possible.

7. The method according to claim 1 wherein said request for a trap to be generated comprises a computer usable media.

8. The method according to claim 7 wherein said computer usable media is accessed via a network communication.

9. A simple network management protocol trap generator software comprising:
a trap accessor for accessing requests to generate a trap;
a trap creator to generate said trap; and
a trap forwarder to forward said trap to a cluster management station.

10. The simple network management protocol trap generator software according to claim 9 for sending a plurality of simple network management protocol traps to a simple network management protocol master agent.

11. The simple network management protocol trap generator software according to claim 9 for sending a plurality of simple network management protocol traps directly to a management station.

12. The simple network management protocol trap generator software according to claim 9 configured to generate a plurality of simple network management protocol traps at a regular interval.

13. The simple network management protocol trap generator software according to claim 9 configured to generate a plurality of simple network management protocol traps at random intervals.

14. The simple network management protocol trap generator software according to claim 9 configured to generate a plurality of simple network management protocol traps according to a statistical distribution.

15. The simple network management protocol trap generator software according to claim 14 wherein said statistical distribution is a Poisson distribution.

16. The simple network management protocol trap generator software according to claim 9 configured to generate a plurality of simple network management protocol traps as fast as possible.

17. The simple network management protocol trap generator software according to claim 9 configured to access a computer usable media to determine a type of trap to be generated.

18. The simple network management protocol trap generator software according to claim 17 wherein said computer usable media is accessed via a network link.

19. A computer usable media comprising computer usable instructions, which when executed on a computer processor implement A method of generating traps for testing a cluster management station, said method comprising:
accessing, at a trap generator, a request for a trap to be generated;
generating, at said trap generator, said trap; and
wherein said trap is generated without requiring an actual failure associated with said trap.

20. The computer usable media according to claim 19 wherein said request for a trap to be generated comprises a computer usable media.
